(19) United States
(12) Patent Application Publication
(10) Pub. No.: US 2026/0049600 A1
(43) Pub. Date: Feb. 19, 2026

(54) Solar Energy Directed to a Cylinder having Voids and Containing a Screw Auger Propeller Used to Generate Electricity

(71) Applicant: Warren Arthur Burtis, San Geronimo, CA (US)

(72) Inventor: Warren Arthur Burtis, San Geronimo, CA (US)

(21) Appl. No.: 19/362,807

(22) Filed: Oct. 20, 2025

Related U.S. Application Data
(63) Continuation-in-part of application No. 19/072,242, filed on Mar. 6, 2025, now Pat. No. 12,448,953.

(51) Int. Cl. F03G 6/04; F03G 6/06

(52) U.S. Cl. CPC F03G 6/045; F03G 6/062; F03G 6/063

(57) ABSTRACT

An elevated or ground level vertical cylinder contains a cone structure that may have an exterior lower static screw auger blade that adds cyclonic turbulence to the rising heated air within the cylinder. The additional turbulence increases the speed of a top propeller which increases the amount of electricity generated. The lower screw auger blade may also be connected to an upper screw auger blade and rotate freely around the cone in response to the rising air in the cylinder to add further torque to a vertical drive shaft. Voids in the cylinder may be used to secure mirrors or lenses to increase the temperature of the cylinder. Mirrors may be attached to the cone to further reflect solar energy to increase the air temperature within the cylinder. The outside perimeter of the cylinder receives solar energy by use of mirrors and lenses directed toward the cylinder.

### RELATED PATENT APPLICATION AND INCORPORATION BY REFERENCE

This is a utility application is a continuation in part (CIP) of utility application Ser. No. 19/072,242 filed on Mar. 6, 2025 which is a CIP of application Ser. No. 18/587,674 filed on Feb. 26, 2024, now U.S. Pat. No. 12,258,946 issued on Mar. 24, 2025, which was based upon and claims priority form U.S. patent application 63/576,661 filed on Feb. 27, 2023. The related applications are incorporated herein by reference and made a part of this application. If any conflict arises between the disclosure of the invention in this utility application and that in the related application, the disclosure in this utility application shall govern. Moreover, the inventor incorporates herein by reference any and all patents, patent applications, and other documents hard copy or electronic, cited or referred to in this application.

### COPYRIGHT AND TRADEMARK NOTICE

This application includes material which is subject or may be subject to copyright and/or trademark protection. The copyright and trademark owner(s) has no objection to the facsimile reproduction by any of the patent disclosure, as it appears in the Patent and Trademark Office files or records, but otherwise reserves all copyright and trademark rights whatsoever.

### BACKGROUND OF THE INVENTION

### (1) Field of the Invention

The invention generally relates to the generation of electricity by use of a shaft rotated by air movement. More particularly, the invention relates to the use of an elevated cylinder receiving heat from concave solar tracking parabolic mirrors with the resulting upward air flow rotating a propeller and shaft. A circular pyramid base or cone structure is disposed upon the ground and within the cylinder to assist in air flow and securing the rotation shaft.

(2) Description of the Known Related Art

U.S. application 2013/0328319 A1 by Guo, published on Dec. 12, 2013 is an example of the prior art's penchant for using exterior shrouds or funnels to direct wind into a wind driven power generating device. The structure of Guo is incompatible with the disclosed embodiments.

U.S. Pat. No. 8,232,665 issued to Sato on Jul. 31, 2012 presents a columnar member comprising a plurality of wind inlets. The voids of the Sato system prevent effective heating of air near the turbine. Thus, Sato teaches away from the disclosed embodiments.

U.S. Pat. No. 9,890,769 issued to Albert on Feb. 13, 2018 presents a system used in building attic spaces where warmed air is pre-existing. Hot attic air enters a funnel and is directed to a horizontally mounted turbine. The structure of Albert works with interior pre-heated air only and by design does not accept outdoor ambient air, which is intentionally kept out by virtue of the funnel and wall system. Moreover, the introduction of outdoor ambient air would cool the interior attic air and destroy the intended purpose of Albert. Thus, Albert teaches away from the disclosed embodiments which use outdoor air only.

U.S. Pat. No. 9,543,945 issued to Coffey on Sep. 27, 2016 discloses an exterior vertical wall system that comprises vertical spaced apart turbine blades. The space between the blades makes heating air near or within the system impractical.

U.S. Pat. No. 9,291,150 issued to Bassett on Mar. 22, 2016 discloses a cone support structure under or within a vertical cylindrical blade drum. The blade drum is in direct communication with ambient air. Bassett teaches away from the disclosed embodiments of using a cylinder to heat and enclose air used to turn a propeller or turbine. Moreover, the cone structure in Bassett does nothing to direct or improve the flow of air to the turbine blades. Bassett highlights a common shortfall in the art by requiring wind driven electrical generation to occur in windy areas. The use of wind power to generate is currently unduly limited to areas that are unusually windy. Thus, there is a need in the art for the presently disclosed embodiments.

### BRIEF SUMMARY OF THE INVENTION

The present invention overcomes shortfalls in the related art by presenting an unobvious and unique combination, configuration and use of elevated hollow cylinders, propellers using shaft in shaft rotational transmission, lower cone structures to direct air flow from the bottom of the cylinders and upwardly into the cylinders and to secure the rotation shafts. Outdoor ambient air within or near a hollow cylinder is heated with concentrated solar energy or concentrated solar power (CSP) by use of exterior parabolic concave reflectors or mirrors. The parabolic concave mirrors direct heat or CSP to the cylinder or other exterior structure or heat retaining housing to cause the internal cylinder air to rise thus moving the propellers and rotating the shafts to generate electricity.

An elevated cylinder may be made of concrete or other material of suitable thermal qualities and be capable of tolerating surface and internal temperatures in the range of 70 to 1,300 degrees Fahrenheit. The elevated cylinder is elevated to overcome shortfalls in the art that fail to draw air from the bottom of a system to provide a continuous air flow while at the same time heating the air near the propeller by heating the walls of the housing or cylinder. Alternative embodiments include cylinders or other exterior housing structures to be disposed at ground level, with ground level air inlets allowing ambient air to enter. The bottom edges of a cylinder may even be subterranean with duct work to allow air to enter the bottom portions of such a cylinder or housing.

The disclosed embodiments overcome shortfalls in the related art by presenting an elevated and vertically oriented cylinder that is configured to heat air near a propeller or turbine while at the same time provide a continuous air flow to a propeller or turbine.

The disclosed embodiments overcome shortfalls in the related art by the venturi effect created by the shape of the wind and shaft support cone which increases the air intake to the cylinder. Moreover, airflow is further increased by the convention heating that increases as temperatures increase upon the cylinder.

The lower circular pyramid structure or cone structure provides an exterior concave arc for improved air flow into the bottom of the cylinder. The top end or top void of the pyramid structure provides an advantage of comprising a collar or bearing to further secure the vertically disposed rotating shaft.

Alternative embodiments include the use of other shapes for the cylinder or outer structure or heat retaining housing. Such shapes include an hourglass, and funnel shapes with the wide base at the top or bottom. Various exterior structure shapes may provide a venturi effect drawing air upwardly at a greater rate of speed.

The cylinders or other heat retaining housings may be heated by a plurality of concave solar tracking parabolic mirrors.

A disclosed embodiment may include an elevated or ground level vertical cylinder contains a cone structure that may have an exterior lower static screw auger blade that adds cyclonic upward and horizontal twist and turbulence to the rising heated air within the cylinder. The additional turbulence increases the container's internal passthrough airflow temperature and speed to help elevate the speed RPM of a top propellers which increases the amount of electricity generated. The lower screw auger blade may also be connected to an upper screw auger blade and rotate freely around the cone in response to the rising air's and the center shaft's rotation in the cylinder; Adding further torque to a primary vertical drive shaft that turns the top propeller that is inside the cylinder. Voids in the cylinder may be used to secure mirrors or lenses or be left vacant to increase the temperature and/or the airflow volume and speed inside of the cylinder. Mirrors may be attached to the cone to further reflect solar energy to increase the air temperature within the cylinder. The outside perimeter of the cylinder receives solar energy by use of mirrors and lenses directed toward the cylinder.

Disclosed embodiments include the use of upper and lower screw auger blades that may be used in a static state to increase the cyclonic turbulence within the cylinder; or together or independently, rotate in response to the upward air movement within the cylinder to add further torque to screw auger shaft which may provide rotational energy to a generator to create electricity.

The known related art fails to disclose, suggest or teach the use of the disclosed physical structures or theory of operation.

### BRIEF DESCRIPTION OF THE DRAWINGS

FIG. 1 is a top and side perspective view of a disclosed embodiment

FIG. 2 is a side perspective view of a disclosed embodiment

FIG. 3 is a side perspective view of a disclosed embodiment and environmental elements

FIG. 4 is a top and side perspective view of a disclosed embodiment and environmental elements

FIG. 5A is a sectional view of a disclosed embodiment

FIG. 5B is a sectional and subterranean view of a power generation system

FIG. 6 is a sectional view of a disclosed embodiment

FIG. 7 is a perspective and sectional view of a dual propeller and dual shaft system

FIG. 8 is a sectional view of a chimney and CO₂ removal system

FIG. 9 is a top view of a plurality of chimney CO₂ removal systems

FIG. 10 is an expanded top view of a chimney CO₂ removal system and related components

FIG. 11 is a sectional view of free wheeling blades in rotational attachment to the inside wall of a cylinder.

FIG. 12 is a perspective view of a flexible vane or flap embodiment

FIG. 13 is a sectional view of a two propeller embodiment

FIG. 14 is a sectional view of an embedment near a heat sink

FIG. 15 is a perspective view of a first heat sink

FIG. 16 is a perspective view of a second heat sink

FIG. 17 is a perspective view of a screw auger shaft 1000 embodiment with voids defined within the cylinder wall and voids defined within the shaft support cone 200

FIG. 18 presents a perspective view of an embodiment using an auger screw blade configuration

### REFERENCE NUMERALS IN THE DRAWINGS

100 Solar heated elevated cylinder system
110 cylinder
111 voids defined by the cylinder 110
112 exterior surface of cylinder
114 interior surface of cylinder
115 upper end of cylinder
116 upper void of cylinder defined by circular cylinder wall
117 lower end of cylinder
118 lower void of cylinder defined by circular cylinder wall
120 wind blade void defined within inner surface of cylinder wall
150 support structure of cylinder
200 circular pyramid base or wind and shaft support cone
201 mirrors or other optics placed upon the shaft support cone 200
205 voids defined by the shaft support cone
210 upper void of wind and shaft support cone
218 lower edge of wind and shaft support cone
220 lower void of wind and shaft support cone
230 outer surface of wind and shaft support cone
300 upper or first propeller
305 blade of upper propeller
310 distal tip of upper propeller
320 rotational shaft or first rotational shaft of upper or first propeller
350 lower or second propeller
355 blade of lower propeller
360 distal tip of lower propeller
370 rotational shaft of lower or second propeller
400 power generator
500 chimney and CO₂ removal system
510 outer chimney wall or chimney funnel
512 shadow of chimney funnel
520 fabric disposed around the chimney funnel
530 solar heat platform
540 perimeter platform skeleton
545 fabric disposed over the perimeter platform skeleton
542 platform support posts
560 CO₂ and water storage containers
570 air blade turbines of chimney and CO₂ removal system
600 reflective mirror or solar tracking parabolic concave mirror
630 support pole for solar tracking parabolic concave mirror
700 ground level
800 free wheeling fan blades
820 Flexible vanes and flaps
860 lower pyramid and fan assembly
870 alternative embodiment
900 a first heat sink embodiment
905 a second heat sink embodiment
1000 upper screw auger blades starting from the top of the cylinder and stopping at the upper void or upper edge 210 of the cone 200. The upper screw arguer blades may also be considered a singular blade.
1003 lower screw auger blades starting at the bottom of the cone and ending at the upper edge 210 or upper void of the cone 200. The lower screw auger blades may also be considered a singular blade.
1100 screw auger shaft
1200 base plate

These and other aspects of the present invention will become apparent upon reading the following detailed description in conjunction with the associated drawings.

### DETAILED DESCRIPTION OF EMBODIMENTS OF THE INVENTION

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout.

Unless otherwise noted in this specification or in the claims, all of the terms used in the specification and the claims will have the meanings normally ascribed to these terms by workers in the art.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

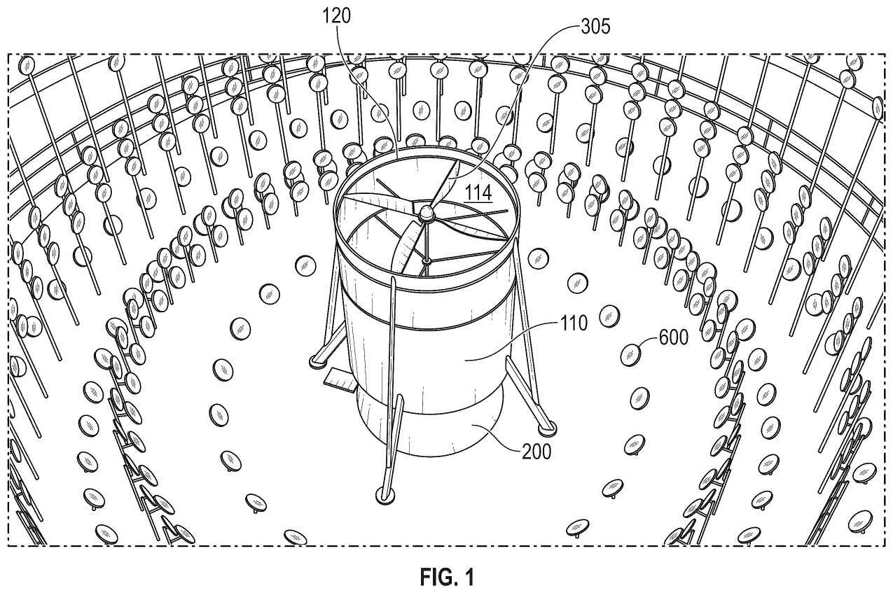

Referring to FIG. 1, a solar heated elevated cylinder system 100 is shown in a park-like setting. A wind and shaft support cone 200 has a bottom portion defining a bottom void that has a greater diameter as compared to the upper portion that defines the upper void. The proportionally or shape overcomes shortfalls in the related art by providing a stable base while providing room for air flow at the bottom of the cylinder.

At the top portion of the cylinder 110, and inside surface 114 defines a wind blade void 120. A distal tip 305 of a propeller or upper propeller may be contained with the wind blade void to provide added stability to the propeller.

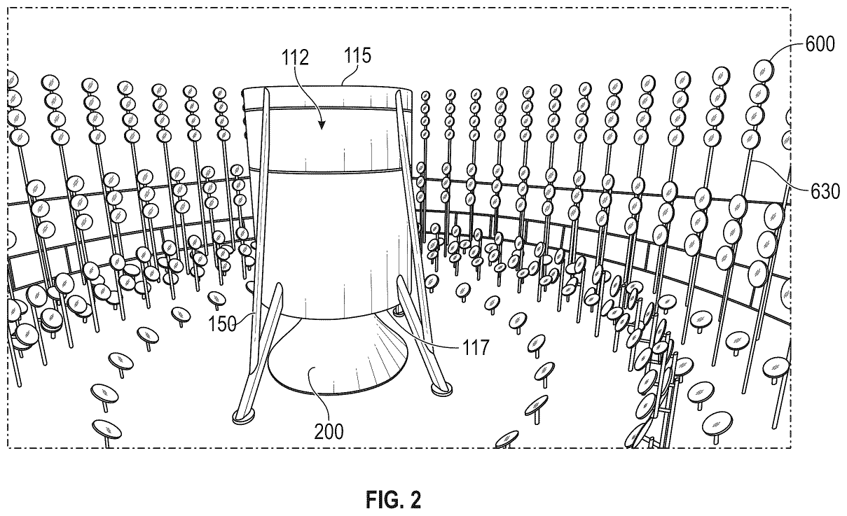

Referring to FIG. 2, a cylinder is shown having an outer surface 112 with the outer surface receiving solar energy or heat from a plurality of mirrors 600 that are sometimes supported by support poles 630. A support structure 150 positions the bottom portion 117 of the cylinder above the ground. This above ground positioning in conjunction with the wind and shaft support cone provide operational advantages in that ambient air may be drawn from the bottom of the cylinder and further allowed or directed into the cylinder by the narrow or narrowing portions of the wind and shaft support cone 200.

Disclosed embodiments may include one or more turbines, propeller systems or other power generation systems disposed at or near or in proximity to the cylinder so as to take advantage of concentrated solar energy or concentrated solar power (CSP) produced by the exterior parabolic concave reflectors or mirrors.

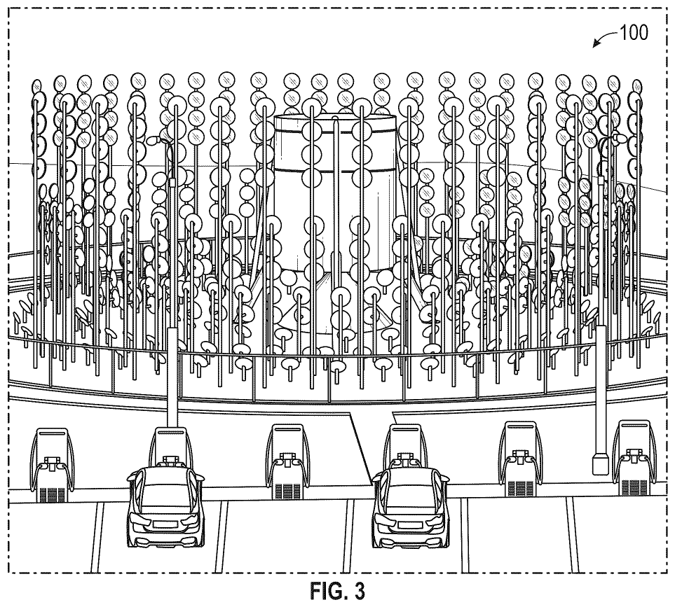

Referring to FIG. 3, a dislocated system 100 is shown in conjunction with electric vehicles and electric vehicle charging stations. The relative compact design of the system allows for a plurality of systems to be installed along roadways or freeways.

Referring to FIG. 4, a disclosed system 100 is shown in the center of a plurality of concave parabolic reflective mirrors disposed upon support poles.

Such mirrors may be movable and programed to rotate to track the position of the sun or otherwise be solar tracking. The mirrors may be positioned in concentric circles around the cylinder and elevated at varying heights to maximize the solar energy or heat directed to and delivered to the cylinder.

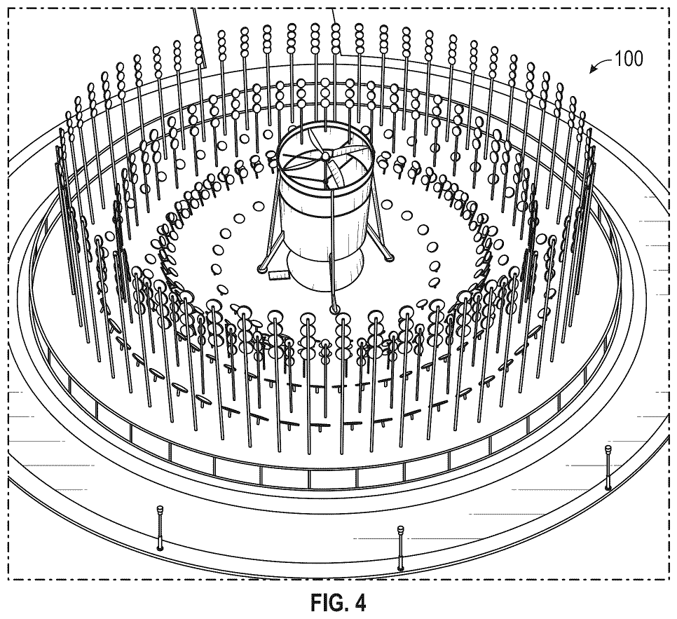

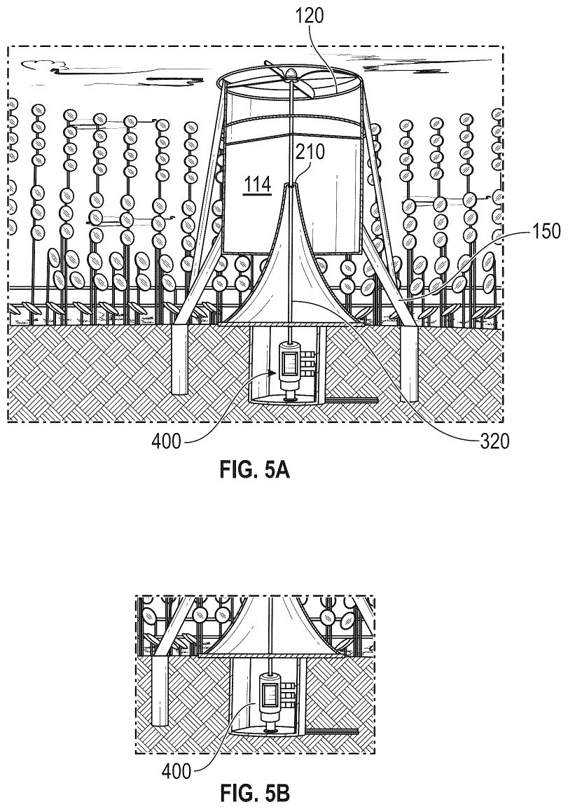

Referring to FIG. 5A a sectional view of a disclosed embodiment shows the inside surface 114 of the cylinder defining a wind blade void 120. Optionally a track may be used to secure or guide the tip of a blade during movement with the track attached to the inside surface of the cylinder.

The upper void 210 of the wind and shaft support cone will accept a rotating shaft. The upper void may also contain a bearing or other mechanism of securing the rotating shaft or concentric shafts in a two propeller/turbine system.

Below ground level 700 or within the cone, a power generator 400 may be in mechanical connection with the rotating shaft to convert the rotation of the shaft into electricity.

With respect to the inner and/or outer surfaces of the cylinder and/or cone structure, upwardly spiraling protrusions channels, bumps, rivulets, bands, rifling or cyclonic twisting may be of benefit in increasing upward airflow convection speed. Such upward spiraling caused by such spiral grooves overcomes shortfalls in the art by maximizing the probability to intermix for mingled-molecular heat conduction/absorption/transfer off of the cylinder and conde surfaces. Expanded per air molecule separation-distances therefore occurs to lighten the air; which increases upward airflow convection speed. The inner cylinder lightened air mass [i.e., greatly lowered air pressure inside cylinder] will then be constantly energized via heat derived from exterior Concentrated Solar Power “CSP”mirrors.

Referring to FIG. 5B, a power generator 400 is shown in connection with the rotating shaft.

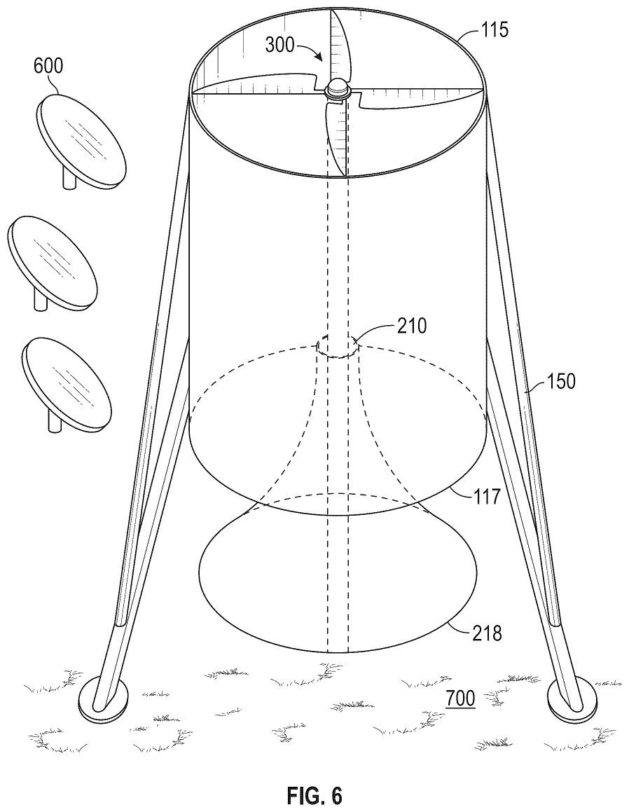

Referring to FIG. 6, a sectional view of a disclosed system 100 is shown with the lower edge 218 of the wind and shaft support cone resting on the ground 700. Reflective mirrors are directing sunlight towards the cylinder. A top or upper propeller 300 is shown disposed at the upper end of the cylinder.

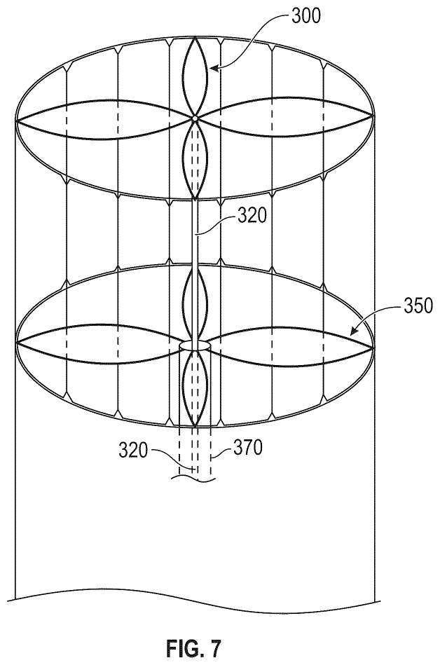

Referring to FIG. 7, a duel propeller or dual turbine system is shown with an upper propeller 300 in mechanical connection with a rotational shaft 320, with said rotational shaft disposed within a hollow second rotational shaft of the lower propeller 350. FIG. 7 also shows an upper propeller mounted above the top edge of the cylinder. Such a configuration allows the lower propeller 350 the maximum amount of air flow. The excess air flow rising past the lower propeller may then be utilized by the upper propeller, with the upper propeller disposed an at upper distance so as to not slow down the airflow used by the lower propeller. The upper propeller may be supported by a frame structure and contained in a circular track. The two shafts may separately integrate or be in attachment to the power generator.

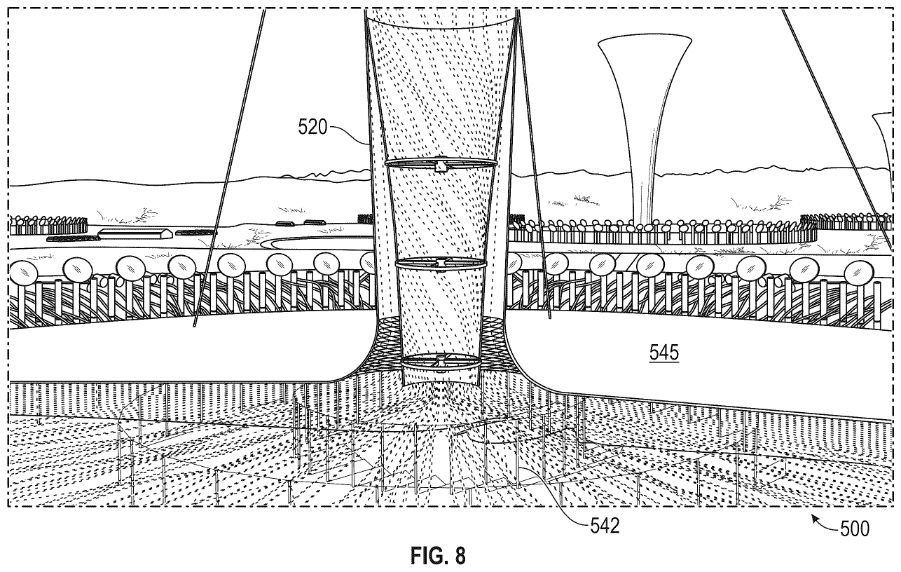

FIG. 8 is a sectional view of a disclosed CO₂ removal system 500 using a chimney system and other components integrated with the disclosed elevated cylinder system 100. The artful use of filters combined with the significant air flow achieved by the cylinder system enables the extraction of CO₂ on an unprecedented scale as CO₂ collectors strip CO₂ out of the wind stream of the system.

In general, air is dawn though the fabric 545 covering the perimeter platform skeleton and air is drawn in through the fabric 520 around the frame of the chimney funnel 510.

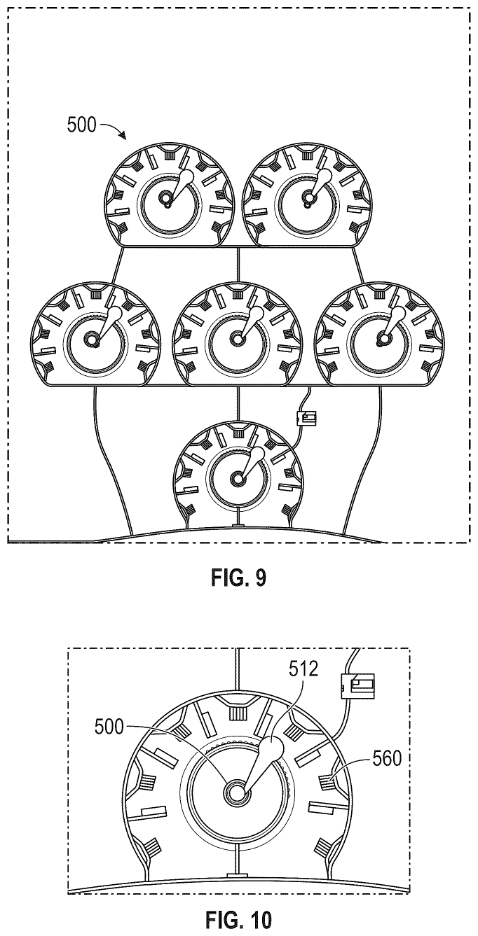

FIG. 9 depicts a plurality of disclosed CO₂ removal systems 500 connected by roads.

FIG. 10 depicts one disclosed CO₂ removal system that includes a plurality of CO₂ and water storage containers 560.

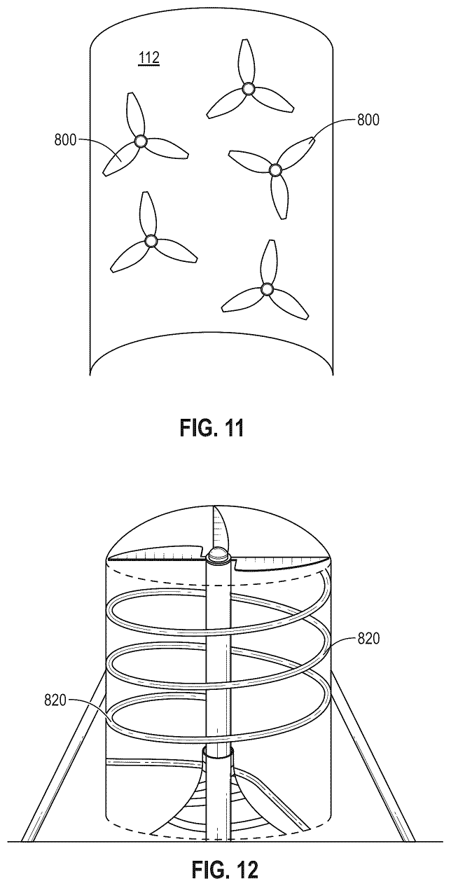

FIG. 11 depicts a interior free wheeling fan blade embodiment. The free wheeling fan blades 800 may be in rotational attachment to the interior 112 of a cylinder. The fan blades may have alternative spin directions and alternate spin ratio fan blades rotational attached to horizontal posts within the cylinder.

The freewheeling fan blades may automatically spin due to their positions inside the vertical tornadic airflow convection. These blades create air turbulence in and around the edges and midsections of the tornadic airflow which forces the convection air to “bounce” onto and to be “repelled” off of the cylinder's hot walls. The freewheeling wind blade's air turbulences increase the airflow's overall turbulent conditions which therefore additionally intermingles heat transfer off the hot interior cylinder walls for mixture into the cylinder's overall vertical airflow procedures.

FIG. 12 depicts flexible vanes or flaps disposed within a cylinder, although an external embodiment is contemplated. The flexible vanes or flaps may be powered by hydraulic or electric motors, computer program controlled, interior and/or exterior vertical, horizontal or other angle vanes/flaps that alter their shape and forms to channel and influence airflow directions and speeds at different times of day.

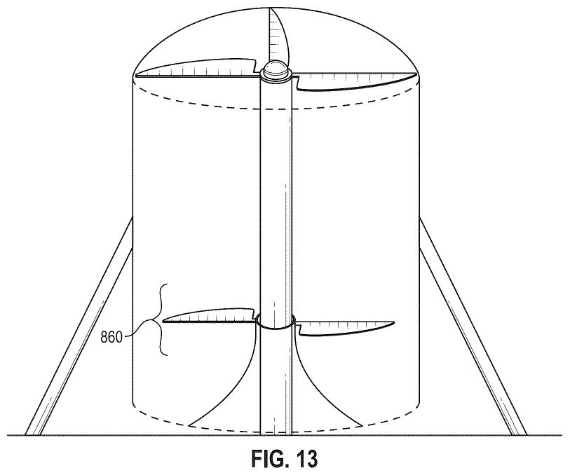

FIG. 13 depicts a wind blade turbine 860 on top of a reverse cone pyramid structure. The wind blade turbine 860 may be hydraulically or electrically powered or freewheeling, and may be disposed atop a cone pyramid structure as shown in FIG. 13. The wind blade 860 will increase airflow turbulence and airflow tornadic spiral inside cylinder bottom area. The wind blade could also be utilized for additional input toward generating electric energy.

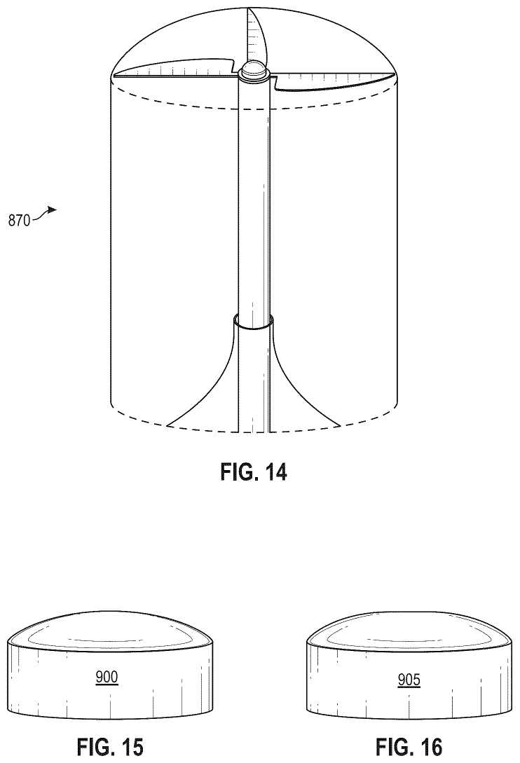

FIG. 14 depicts an embodiment near a heat sink

FIG. 15 and FIG. 16 depict embodiments of a heat sink. A heat sink may comprise molten salt, water mixtures, stone beds, etc.; for additional airflow warmings. These heat-sinks may be positioned at and around areas of geographies where the disclosed embodiments are located. The heat sinks' retained heat will be increased during sunshine hours and released during darkened hours for keeping the airflow active inside the disclosed embodiments.

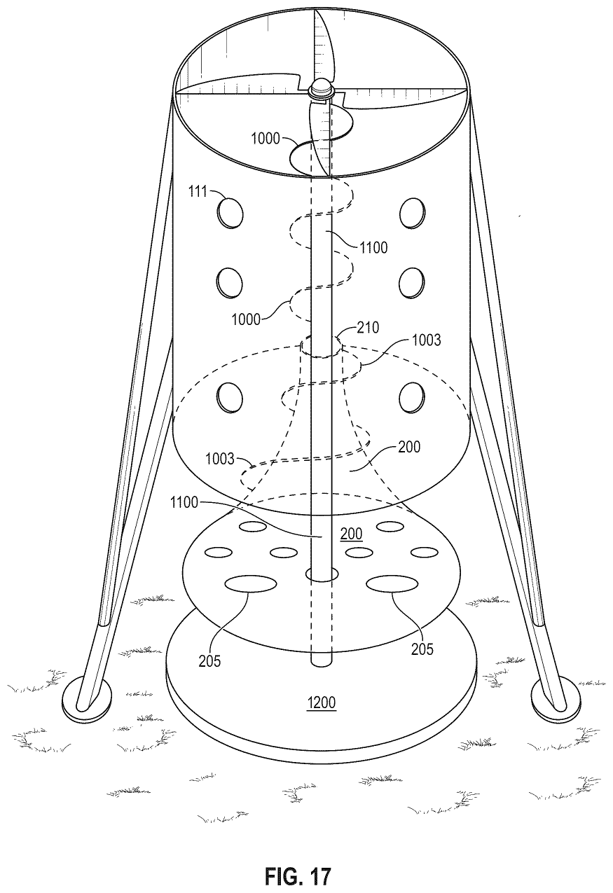

FIG. 17 discloses an embodiment having a top propeller at the top of the cylinder and the top propeller at a bottom side, is attached to a screw auger shaft 1100. At an area below the top propeller, a screw auger blade 1000 or screw auger blades are attached to the screw auger shaft and run down the screw auger shaft to an area above the top of the upper void 210 of a wind and shaft support cone 200. At the upper void, the wind and shaft support cone is attached to screw auger blades 1000. In this configuration, upward moving air in the cylinder is harnesses by screw auger blades that are attached to both the cone 200 and upper shaft area. This configuration has a mechanical or aerodynamic advantage in that auger blades attached to the cone have a greater surface area as opposed to auger blades attached to a straight auger shaft. The curvature of the cone 200 allows for a greater length of an auger blade. In this configuration, the cone 200 also spins. A lower base 1100 may be used to stabilize the screw auger shaft and may act as a heat sink.

The embodiment of FIG. 17 or any other embodiment may include voids within the cylinder walls, or voids with or without glass, louvers or other inserts on locations of the cylinder wall for cylinder heat increase and airflow control. The screw auger blade system assists in airflow upward directional speed, airflow turbulence and shaft rotation torque. The rotation of the cone allows for optimization of the relatively large surface area of the cone, such that screw auger blades attached to the cone have a greater surface areas as opposed to being attached to a traditional straight shaft.

Cone mirrors and mirrors of any shape or size or other items placed upon or in walls or voids of the cylinder can reflectively transfer some the exterior parabolic mirrors heat into the interior of the cylinder and or cone.

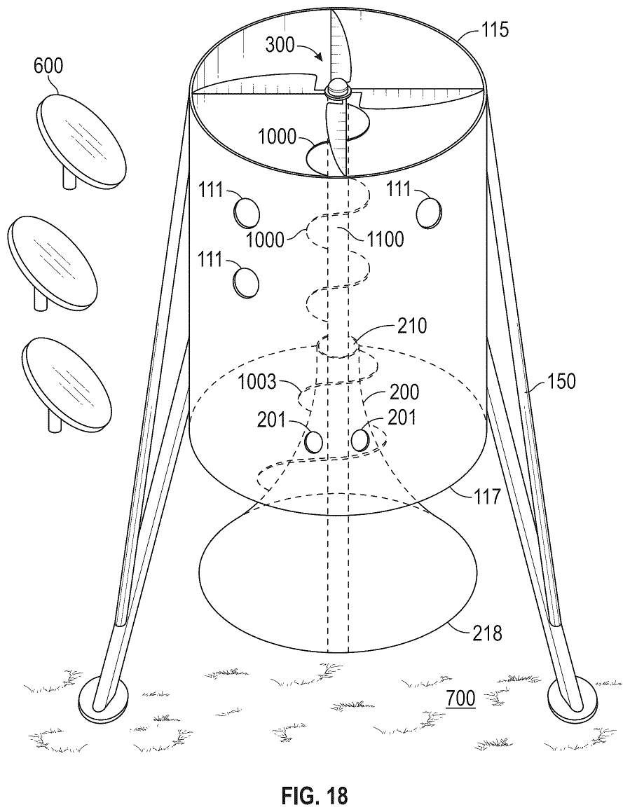

FIG. 18 discloses an embodiment using upper screw auger blades 1000 and lower screw auger blades 1003. The lower screw auger blades may be attached to the cone to be static, with the lower screw auger blades used to increase or create a cyclonic turbulence to increase the upward air flow. The lower screw auger blades 1003 may be configured to harness upward air flow and move around the exterior of the cone and be attached to the upper screw auger blades 1000. In such a configuration, the lower screw blades may be fixedly attached to the cone wherein the cone rotates.

The cone 200 may have mirrors or other optics 201 to further reflect solar energy within the cylinder and thus increase the air temperature within the cylinder.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only the systems described herein. The various embodiments described herein can be combined to provide further embodiments. These and other changes can be made to the invention in light of the detailed description.

All the above references and U.S. patents and applications are incorporated herein by reference. Aspects of the invention can be modified, if necessary, to employ the systems, functions and concepts of the various patents and applications described above to provide yet further embodiments of the invention.

These and other changes can be made to the invention in light of the above detailed description. In general, the terms used in the following claims, should not be construed to limit the invention to the specific embodiments disclosed in the specification, unless the above detailed description explicitly defines such terms. Accordingly, the actual scope of the invention encompasses the disclosed embodiments and all equivalent ways of practicing or implementing the invention under the claims.

While certain aspects of the invention are presented below in certain claim forms, the inventors contemplate the various aspects of the invention in any number of claim forms.

What is claimed is:

1. A system (100) to generate electricity, the system comprising:
a) a cylinder (110) comprising a circular cylinder wall, an interior surface (114), an exterior surface (112), an upper end (115), a lower end (117), an upper void (116) defined by the circular cylinder wall at the upper end, and a lower void (118) defined by the circular cylinder wall at the lower end;
b) a plurality of voids (111) defined within the cylinder;
c) a screw auger shaft disposed within the cylinder, the screw auger shaft having a first end attached to a propeller (300) and the screw auger shaft having a second end attached to a power generator;
c) a wind and shaft support cone (200) disposed within the cylinder, the wind and shaft support cone defining an upper void (210) the upper void accepting the screw auger shaft;
d) upper screw auger blades (1000) attached to the screw auger shaft below the point of attachment to the propeller and to the point of intersection with the wind and shaft support cone upper void (210);
f) lower screw auger blades (1003) in fixed attachment upon the wind and shaft support cone from the at the upper void of the wind and shaft support cone to the bottom of the wind and shaft support cone;
g) wherein the system is configured to heat the air within the cylinder for continuous air flow to rotate the propellor and the upper screw auger blades and wherein the lower screw auger blades are stationary and add cyclonic turbulence to the air within the cylinder.

2. The system of claim 1 wherein the cylinder is positioned above ground level.

3. The system of claim 1 wherein lenses are disposed within the voids of the cylinder to increase the temperature of the air within the cylinder.

4. The system of claim 1 further including a plurality of parabolic concave mirrors directed towards the cylinder.

5. The system of claim 1 further including mirrors or lenses (201) disposed upon the wind and shaft support cone.

6. The system of claim 1 wherein the lower screw auger blades are not attached to the wind and shaft support cone and rotate around the wind and shaft support cone and the lower screw auger blades are attached to the upper screw auger blades.

7. The system of claim 1 wherein the wind and shaft support cone rotates and the lower screw auger blades is attached to the upper screw auger blades and the lower screw auger blades remain attached to the wind and shaft support cone.
